(19) United States
(12) Patent Application Publication
(10) Pub. No.: US 2004/0105976 A1
(43) Pub. Date: Jun. 3, 2004

(54) Colored adhesive tape

(75) Inventor: Kenneth A. Thomas, Winnipeg (CA)

Correspondence Address: ADE & COMPANY, 1700-360 MAIN STREET, WINNIPEG, MB, R3C3Z3, CA

(73) Assignee: KT Holdings Ltd., Winnipeg (CA)

(21) Appl. No.: 10/694,860

(22) Filed: Oct. 29, 2003

Related U.S. Application Data
(60) Provisional application No. 60/430,385, filed on Dec. 3, 2002.

(51) Int. Cl. B32B 31/00; B32B 7/12

(52) U.S. Cl. 428/346; 156/271; 156/307.5

(57) ABSTRACT

A coloured tape arranged for attachment as individual tabs to a paper stock file folder is formed by providing a base film and applying to the base film a first layer comprising a laminating adhesive containing the colouring agent from which the solvents are driven off. When dried, a hot melt adhesive is applied to the laminating agent and chilled. The tape is wound into a roll. At an end use location the tape is cut into tabs and the tabs applied to the paper stock using the hot melt adhesive by heat or by pressure sensitive action to cause the bond to the paper. The application of the colouring agent to the laminating adhesive allows ready admixture of the liquid colouring agent or dry pigments using the solvents in the laminating adhesive. As the colouring agent is immediately adjacent the base film, it is readily visible through the base film as a bold colour.

This invention relates to a method of forming a coloured adhesive tape, a tape formed by the method and a file folder including a tab formed from the tape.

### BACKGROUND OF THE INVENTION

Tapes which are typically used for forming tabs for attachment to paper have been formed in prior art methods as described hereinafter and the tapes are subsequently cut into individual tabs which are arranged for attachment to a paper sheet to form a coloured tab. Such coloured tabs have a requirement for a bold colour since the function of the tab primarily is to act as a marker or indicator for visually distinguishing the paper sheet or a file folder to which the tab is attached.

In addition the adhesive of the tab must have sufficient strength to maintain a proper position on the paper sheet. The adhesive must therefore provide sufficient strength such that removal of the tab causes tearing of fibres of the paper substrate, as determined by a simple pulling test on the tab when applied to the paper stock.

Previous tapes have been formed from a base form of PET, commonly having a thickness of the order of 0.002 inch. This thickness provides sufficient strength in the base film such that the film cannot be readily torn when applied to the paper substrate. This film has the necessary transparency so that the colour can be viewed through the thickness of the film without interfering with the clarity of the colour or the boldness of the colour.

In one method for manufacturing a film of this type for subsequent slitting into tape and subsequent cutting into tabs, the base film of PET is co-extruded or laminated with a covering layer on one surface of the base film of EAA where the EM is mixed with the colour pigments to provide the required coloured layer. Thus the film is simple and relatively inexpensive since it is formed solely of the two layers.

However this method has the significant disadvantage that the co-extrusion process requires large capital investment on equipment and the colours are costly to purge from the extruder during colour changes so that there is a significant disincentive to run small batches of the material.

Up till now, smaller batches have been manufactured using a sheet of the base film of PET which is then laminated to a commercially available sheet of a thinner layer of PET acting as a carrier layer for a coating of EVA. The commercially available sheet of co-extruded PET and EVA is available without colouring so that the colouring of the combined laminate is effect by providing an adhesive between the main PET layer and the composite sheet where the adhesive carries the pigment and/or dyes and therefore acts as the colouring of the laminated sheet material.

This construction has performed satisfactorily and provides both the necessary colour characteristics and the necessary aggressiveness of the adhesive. However, the construction is relatively complex and includes additional layers and additional lamination processes which significantly acts to increase the cost of the finished product.

Ethylene Acrylic Acid (EM) Copolymer can make up a number of resins that are flexible, specialty thermoplastics created by high-pressure copolymerization of ethylene (E) and acrylic acid (AA). Resulting EM copolymers can be injection molded or extruded at slightly lower processing temperatures than polyethylene. Performance properties include excellent toughness, light weight and durability in aggressive chemical environments.

EAA is available in a variety of grades, optimized for processing productivity and end-use performance in applications such as footwear, glass and metal coatings, injection molded parts, carriers for colour concentrates, wire and cable insulation, and adhesive films and compounds. The resins offer strong adhesion to foil, paper, metals and glass, and excellent resistance to grease and oils.

### SUMMARY OF THE INVENTION

It is one object of the present invention, therefore, to provide an improved method of forming a coloured adhesive tape.

According to one aspect of the invention there is provided a method for forming a coloured tape comprising:

providing a base film of a polymeric material having a first surface and a second surface;

applying a first layer of a dry laminating adhesive so as to cover the first surface of the base film;

applying a second layer of a melted hot melt adhesive on top of the first layer and chilling the second layer to form a solidified layer of hot melt adhesive;

forming the tape in a tape width;

and winding the tape into a roll;

wherein a colouring agent is added into or with the first layer so as to provide a colour to the tape visible through the base film and the laminating adhesive acts as a tie layer between the hot melt adhesive and the base film of a polymeric material.

Preferably the method includes longitudinally slitting the film and the first and second layers thereon into a plurality of side by side tapes and winding the tapes into individual supply packages for supply to an end use machine.

Preferably the base film is PET since this provides the required stiffness and tear strength conventionally used for tabbing tape, although other materials can be used such as polyolefins and nylon.

Preferably the base film and the first and second layers thereon are cut into a plurality of coloured tabs which are arranged for bonding to a paper sheet as a tab thereon.

Preferably the base film has a thickness in the range 0.00048 inches to 0.004 inches and more preferably of the of the order of 0.002 to 0.003 inch.

Preferably the tabs consist solely of the base film and the first and second layers thereon and the colouring agent in the first layer.

Preferably the dry laminating layer is applied as a liquid including solvents which are driven off prior to application of the second layer.

Preferably the colouring agent is admixed with the liquid laminating layer prior to application to the base film, and the colouring agent can comprise a liquid or powder pigments applied as an admixture into the liquid laminating layer. However it is also possible for the colouring agent to be applied separately from the laminating layer, that is it can be applied as a separate transparent ink layer, prior to the application of a clear dry laminating adhesive.

Preferably the hot melt adhesive is of the type which arranged to be bonded to a substrate by heating the adhesive to cause melting and re-setting of the adhesive.

However also the hot melt adhesive may be of the pressure sensitive type in which case the second surface of the base film is arranged to have release characteristics relative to the pressure sensitive adhesive.

According to a second aspect of the invention there is provided a coloured tape comprising:

a base film of a polymeric material having a first surface and a second surface;

a first layer of a dry laminating adhesive applied so as to cover the first surface of the base film;

a second layer of a set hot melt adhesive on top of the first layer;

the tape having a tape width and being wound into a roll;

wherein a colouring agent is contained within the first layer so as to provide a colour to the tape visible through the base film.

According to a third aspect of the invention there is provided a combination comprising

a paper substrate;

a coloured tab cut from a tabbing tape attached to the substrate comprising:

a base film of a polymeric material having a first surface and a second surface;

a first layer of a dry laminating adhesive applied so as to cover the first surface of the base film;

a second layer of a set hot melt adhesive on top of the first layer;

the tab being attached to the substrate by the hot melt adhesive;

wherein a colouring agent is contained within the first layer so as to provide a colour to the tape visible through the base film.

### BRIEF DESCRIPTION OF THE DRAWINGS

One embodiment of the invention will now be described in conjunction with the accompanying drawings in which:

FIG. 1 is a side elevational view of a method for forming a coloured adhesive film according to the present invention.

FIG. 2 is a cross sectional view of a portion of the film of FIG. 1.

FIG. 3 is a cross sectional view of a tab formed from the film of FIG. 2 attached to a paper substrate.

In the drawings like characters of reference indicate corresponding parts in the different figures.

### DETAILED DESCRIPTION

In FIG. 1 is shown a process for manufacturing a film having a visible colour and having an adhesive layer on one surface. The method comprises providing a base film 10 in a roll of the film. The film is unwound through a drive system 11 for supply into the process. The film has an upper surface 12 and a bottom surface 13.

On the surface 12 is applied a first layer 14. The first layer 14 is a liquid layer formed from a liquid laminating adhesive 15 admixed with pigment 16 in a mixing chamber 17. As shown the application system comprises a gravure roller 18 onto which the liquid mixture is applied so that the roller 18 carries the liquid onto the surface to be applied as a coating layer covering the whole of the surface 12.

Other coating systems well known to one skilled in the art can be used.

Downstream of the coating process, the film and the layer are passed through a heating chamber to drive off solvent from the liquid layer applied thus leaving the laminating adhesive coating in dry form carried on the film.

Laminating adhesive is conventionally used for laminating two films together and many examples are available from a number of suppliers such as Rohm & Haas, HB Fuller, and Bostik to name a few. One example from Rohm & Haas is known under the trade name “Adcote” which is a polyester based adhesive which is mixed with solvents to form a liquid for application so that the solvents can be driven off by the heat to leave the adhesive and pigments applied to and attached to the base film.

Suitable colouring agents can be supplied in liquid form or in dry pigment form. Liquid colouring agents are available from Hoechst, and Ciba. Pigments are available from Hoechst, Ciba, Clariant, ICI, and BASF. The presence of the solvents allows the colouring agent to be readily admixed with the laminating adhesive and applied therewith. In a typical example, the amount of colouring agent may be in the range 0.05 to 10 percentage by weight of the total applied liquid.

Such dry laminating adhesives are generally of a type which generate an initial bond with the adjacent materials with that bond curing over time to generate a matured bond.

When the solvents are driven off, the dried layer on the base film is carried to a second coating station 30 where a hot melt adhesive is applied using well known processes in a melted condition and passed over a chill roller 31 to set the hot melt adhesive into an applied second layer 32.

Suitable hot melt adhesives are available from for example National Starch, Nacan, HB Fuller and Bostik. The hot melt adhesives can be of the type in which the adhesive is activated by heat or of the type which are pressure sensitive as both types are readily available. If pressure sensitive, a silicone coating station (not shown) is provided which applies a release coating to the rear or bottom surface of the base film.

Downstream of the hot melt station 30, the film is slit using a slitting system 19 to divide the film into a plurality of side by side tapes which are wound onto a winding system schematically indicated at 20.

The individual rolled packages formed in the winding system 20 are supplied to an end user who acts to cut the tapes into individual tabs which are then supplied to customers in a suitable packaged form well known to one skilled in the art for application of the individual tab to a paper sheet.

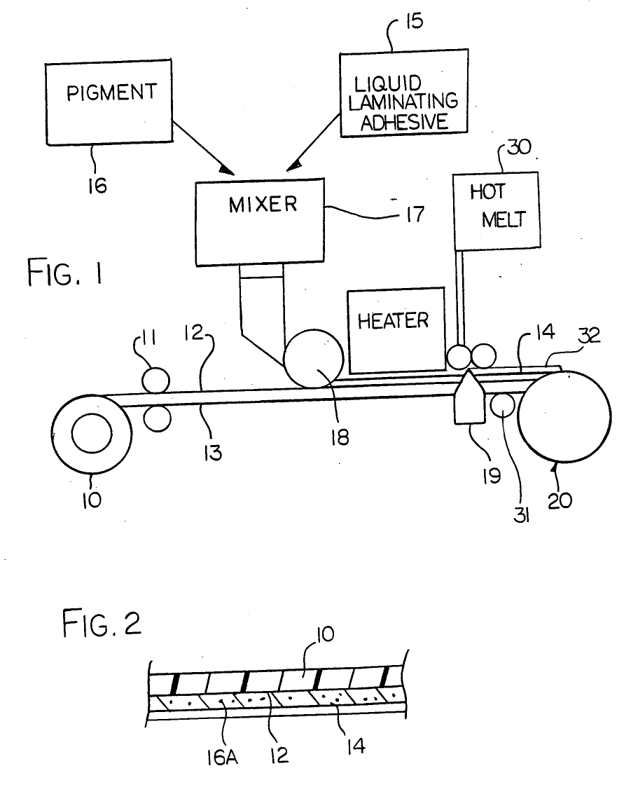

In FIG. 2 the base film layer 10 has on its surface 12 the layer 14 of laminating adhesive with pigment and/or dye components 16A admixed into the adhesive and thus spread throughout the layer as the solvents are driven off. The pigments or dye can be viewed directly from the side of the layer 14 or can be viewed through the transparent base film 10 as a bold clear colour.

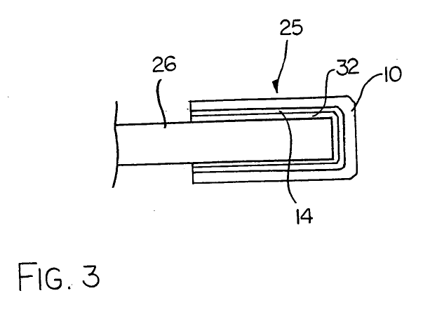

In FIG. 3 is shown the use of a tab 25 attached to a sheet 26 of a paper substrate forming a file folder. The layer 10 is exposed outwardly and the adhesive layer 32 attaches the base film to the outside surface of the paper substrate. Again the colour being in the layer 14 immediately adjacent the base film can be viewed through the film 10 thus making the tab have the appearance of the bold strong colour defined by the pigments or dye within the layer 14.

Suitable pigments and/or dyes are available to one skilled in the art from various suppliers and utilize conventional colour coding techniques to ensure that a particularly required colour can be generated by a single one of the pigments or by admixtures of pigments.

The liquid laminating adhesive can be admixed with the pigments to provide a solution which can be applied using the gravure roller. Admixing techniques are known to one skilled in the art which will provide a suitable suspension of the pigments in the solution while the adhesive remains in solution within the solvents.

The admixture remains sufficiently liquid for application by conventional liquid application techniques.

The liquid adhesive available from the above supplier provides, when coated and dried, a sufficient level of aggressiveness to provide the paper tear strength required for the tabbing application. At the same time the same product allows the application of the pigments without affecting the properties of the material.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A method for forming a coloured tape comprising:
providing a base film of a polymeric material having a first surface and second surface;
applying a first layer of a laminating adhesive so as to cover the first surface of the base film;
drying the laminating adhesive to provide a dry layer thereon;
applying a second layer of a melted hot melt adhesive on top of the first layer and cooling the second layer to form a solidified layer of hot melt adhesive;
forming the tape in a tape width;
and winding the tape into a roll;
wherein a colouring agent is added into the first layer so as to provide a colour to the tape visible through the base film.

2. The method according to claim 1 including longitudinally slitting the film and the first and second layers thereon into a plurality of side by side tapes and winding the tapes into individual supply packages for supply to an end use machine.

3. The method according to claim 1 wherein the base film is PET.

4. The method according to claim 1 wherein the base film and the first and second layers thereon are cut into a plurality of coloured tabs which are arranged for bonding to a paper sheet as a tab thereon.

5. The method according to claim 4 wherein the base film and the first and second layers thereon are cut into a plurality of coloured tabs which are bonded by the hot melt adhesive to a paper sheet as a tab thereon.

6. The method according to claim 1 wherein the base film has a thickness in the range 0.00048 inches to 0.004 inches.

7. The method according to claim 4 wherein the tabs consist solely of the base film and the first and second layers thereon and the colouring agent in the first layer.

8. The method according to claim 1 wherein the dry laminating layer is applied as a liquid including solvents which are driven off prior to application of the second layer.

9. The method according to claim 1 wherein the colouring agent is admixed with the liquid laminating layer prior to application to the base film.

10. The method according to claim 1 wherein the hot melt adhesive is arranged to be bonded to a substrate by heating the adhesive.

11. The method according to claim 1 wherein the hot melt adhesive is arranged to be pressure sensitive and the second surface of the base film is arranged to have release characteristics relative to the pressure sensitive adhesive.

12. A coloured tape comprising:
a base film of a polymeric material having a first surface and a second surface;
a first layer of a dry laminating adhesive covering the first surface of the base film;
a second layer of a set hot melt adhesive on top of the first layer;
the tape having a tape width and being wound into a roll;
wherein a colouring agent is contained within the first layer so as to provide a colour to the tape visible through the base film.

13. The tape according to claim 12 wherein the base film is PET.

14. The tape according to claim 12 wherein the base film has a thickness in the range 0.00048 inches to 0.004 inches.

15. The method according to claim 12 wherein the tape consist solely of the base film and the first and second layers thereon and the colouring agent in the first layer.

16. The tape according to claim 12 wherein the hot melt adhesive is arranged to be bonded to a substrate by heating of the adhesive.

17. The tape according to claim 12 wherein the hot melt adhesive is arranged to be pressure sensitive and the second surface of the base film is arranged to have release characteristics relative to the pressure sensitive adhesive.

18. A combination comprising
a paper substrate;
a coloured tab formed from a tabbing tape attached to the substrate comprising:
a base film of a polymeric material having a first surface and a second surface;
a first layer of a dry laminating adhesive covering the first surface of the base film;
a second layer of a set hot melt adhesive on top of the first layer;
the tab being attached to the substrate by the hot melt adhesive;
wherein a colouring agent is contained within the first layer so as to provide a colour to the tape visible through the base film.

19. The file folder according to claim 18 wherein the base film is PET.

20. The file folder according to claim 18 wherein the base film has a thickness in the range 0.00048 inches to 0.004 inches.

21. The file folder according to claim 18 wherein the tape consist solely of the base film and the first and second layers thereon and the colouring agent in the first layer.

22. The file folder according to claim 18 wherein the hot melt adhesive is bonded to the substrate by heating of the adhesive.

23. The file folder according to claim 18 wherein the hot melt adhesive is pressure sensitively attached to the substrate.
